(19) United States
(12) Patent Application Publication
(10) Pub. No.: US 2021/0382612 A1
(43) Pub. Date: Dec. 9, 2021

(54) INFORMATION PROCESSING APPARATUS, CONTROL METHOD FOR INFORMATION PROCESSING APPARATUS, AND NON-TRANSITORY COMPUTER-READABLE STORAGE MEDIUM

(71) Applicant: CANON KABUSHIKI KAISHA, Tokyo (JP)

(72) Inventor: Masanori Fukada, Tokyo (JP)

(21) Appl. No.: 17/337,247

(22) Filed: Jun. 2, 2021

(30) Foreign Application Priority Data
Jun. 8, 2020 (JP) 2020-099614

(51) Int. Cl. G06F 3/0484; G06F 3/14

(52) U.S. Cl. CPC G06F 3/04847; G06F 3/14

(57) ABSTRACT

An information processing apparatus is provided that displays, on a display unit, an image included in an image file that conforms with a predetermined image file format with a structure that includes an image data region for storing an image and a metadata region for storing metadata related to the image. The information processing apparatus, in a case where identification information related to slideshow display is stored in the metadata region, decides on a playback condition for an image group designated by the identification information in accordance with setting information set on the information processing apparatus, and performs slideshow display of the image group on the display unit in accordance with the playback condition that has been decided on by the information processing apparatus.

### BACKGROUND

### Field

The present disclosure relates to a technique for performing slideshow playback of an image file that stores data of one or more images.

### Description of the Related Art

According to MPEG (Moving Pictures Experts Group), standardization for storing a single still image, a plurality of still images, or an image sequence (e.g., still images obtained through burst shooting) in one file has been implemented. This standard is called HEIF (High Efficiency Image File Format), and enables exchanges, modification, and display of images and image sequences. Also, HEIF is a storage format that has been expanded based on tools prescribed by ISO Base Media File Format (ISOBMFF). Standardization of HEIF has been in progress under the name “Image File Format” according to ISO/IEC 23008-12 (Part 12). Furthermore, HEIF prescribes a normative structure including metadata, and prescribes a method of associating metadata with images, and a configuration of metadata in a specific format.

Meanwhile, image generation apparatuses with an image generation function, such as cameras and smartphones, have been given a variety of functions in recent years, and are capable of generating a variety of types of information that include not only the date/time of shooting, image size, and image quality, but also information regarding the context at the time of shooting, metadata of shot image data, and so on. For example, information for identifying a subject and a scene at the time of shooting, various types of shooting setting information, and the like are generated together with image data. Such information related to the image data can be stored in an HEIF file as metadata, together with the image data. Furthermore, there are applications that have a function of displaying a plurality of images while automatically switching among them in order. In many applications, this function is called a slideshow. Japanese Patent Laid-Open No. 2001-103415 describes the execution of slideshow display upon generation of an order table for performing the slideshow display.

According to HEIF, it is also possible to generate an image file that is intended to store a plurality of pieces of image data and display them in a slideshow. Technology under Consideration on ISO/IEC 23008-12 (w18819) has considered storage of metadata aimed at slideshow display of a plurality of images stored in an HEIF file.

While HEIF prescribes a normative structure including metadata, it does not define in detail how an application behaves when an HEIF file stores groups (image groups) for slideshow display of stored pieces of image data. For example, HEIF does not define which group is selected and displayed in a slideshow in a case where a plurality of slideshow groups are stored, and how slideshow display is performed in a case where the slideshow display is performed together with a non-HEIF file. Therefore, conventionally, slideshow playback that conforms with the intention of a user who views a slideshow cannot be performed in an effective way.

### SUMMARY

Various embodiments of the present disclosure provide a display mechanism for a case where an HEIF file stores an image group that is intended for slideshow display.

According to various embodiments of the present disclosure, there is provided an information processing apparatus that displays, on a display unit, an image included in an image file that conforms with a predetermined image file format with a structure that includes an image data region for storing an image and a metadata region for storing metadata related to the image, the information processing apparatus includes: a decision unit configured to, in a case where identification information related to slideshow display is stored in the metadata region, decide on a playback condition for an image group designated by the identification information in accordance with setting information set on the information processing apparatus; and a display control unit configured to perform slideshow display of the image group on the display unit in accordance with the playback condition that has been decided on by the deciding unit.

Further features of the present disclosure will become apparent from the following description of exemplary embodiments (with reference to the attached drawings).

### BRIEF DESCRIPTION OF THE DRAWINGS

FIG. 1 is a block diagram showing a configuration of an information processing apparatus according to one embodiment.

FIG. 2 is a flowchart of slideshow playback processing for an image file according to one embodiment.

FIG. 3 is a flowchart of slideshow playback processing for an HEIF file according to one embodiment.

FIG. 4 is a flowchart of playback condition decision processing for a slide show group according to one embodiment.

FIGS. 5A and 5B are flowcharts of processing for deciding on a slideshow playback group according to one embodiment.

FIG. 6 is a flowchart of processing for deciding on a playback period for a slide show group according to one embodiment.

FIG. 7 is a flowchart of processing for deciding on the order of images to be played back in a slide show group according to one embodiment.

FIG. 8 is a diagram showing a structure of an HEIF file according to one embodiment.

FIG. 9 is a diagram showing examples of a setting screen and a slideshow display screen on the information processing apparatus according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Configuration of Information Processing Apparatus

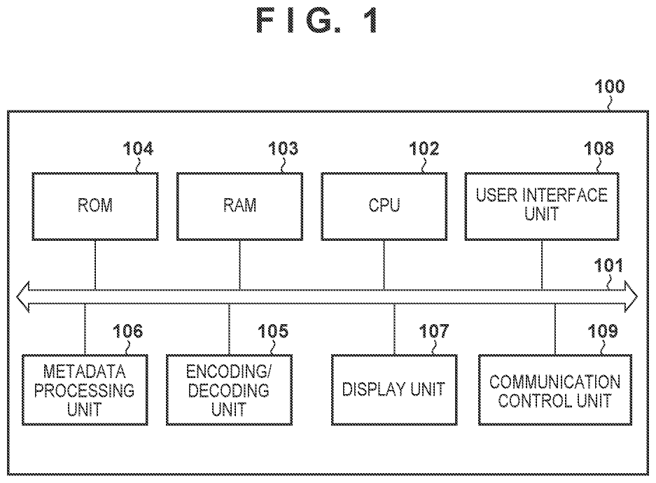

FIG. 1 shows one example of a configuration of an information processing apparatus 100 according to one embodiment. A CPU (Central Processing Unit) 102, a RAM (Random Access Memory) 103 that acts a temporary storage apparatus at the time of the execution of a system program, and a ROM (Read Only Memory) 104 which is a nonvolatile storage apparatus for storing the system program and the like, are connected to a system bus 101 in the information processing apparatus 100. The system program and application programs are read from the ROM 104 into the RAM 103, and executed by the CPU 102. Furthermore, an encoding/decoding unit 105, a metadata processing unit 106, a display unit 107, a user interface unit 108, and a communication control unit 109 are connected to the system bus 101. The system bus 101 transmits data between these blocks. In addition, the RAM 103 includes an output buffer, and is also used as a data buffer for slideshow display processing and an output destination of data that is temporarily stored at the time of analysis of metadata in an image file. Note that the numbers of the CPU 102, RAM 103, and ROM 104 may each be two or more.

The encoding/decoding unit 105 is a video codec for moving images and still images that are compliant with H.265 (HEVC), H.264 (AVC), AV1, JPEG, and the like, and executes processing for encoding and decoding data of still images and moving images. The metadata processing unit 106 analyzes metadata (data/information in a metadata region) stored in a file, and performs metadata processing at the time of playback of still images and moving images. Specifically, the metadata processing unit 106 analyzes that an image file has been stored in compliance with a predetermined file format (e.g., HEIF), and obtains metadata (obtains information related to still images and moving images, and obtains parameter information related to encoded data). The encoding/decoding unit 105 decodes data with use of metadata obtained by the metadata processing unit 106 and encoded data (image data). The metadata processing unit 106 obtains data (decoded data), stores the data in a buffer, and executes preprocessing for display. The metadata processing unit 106 also performs analysis processing with respect to metadata that has been stored in a predetermined image file format.

The display unit 107 performs display processing related to the applications/functions executed on the information processing apparatus 100. The display unit 107 is configured as a screen, such as a liquid crystal display apparatus, or is configured to include this screen. The display unit 107 may also include a screen touch sensor so as to enable a user to operate applications via a GUI (Graphic User Interface). Furthermore, the display unit 107 may be configured to provide a display that allows the user to designate setting information when slideshow playback is performed. The user interface unit 108 is an interface for accepting an operation (input) performed by the user with respect to the information processing apparatus 100. The user interface unit 108 is composed of, for example, such physical operation interfaces as buttons, switches, a mouse, a keyboard, and a touchscreen.

The communication control unit 109 is a network interface that connects to a network and transmits/receives transmission frames. The communication control unit 109 is, for example, the PHY and MAC (transmission media control processing) of the Ethernet® of a wired LAN. Alternatively, when the information processing apparatus 100 is connectable to a wireless LAN, the communication control unit 109 includes a controller that executes wireless LAN control of, for example, IEEE 802.11a/b/g/n/ac/ax, an RF circuit, and an antenna.

### Flow of Slideshow Playback Processing for Image Files

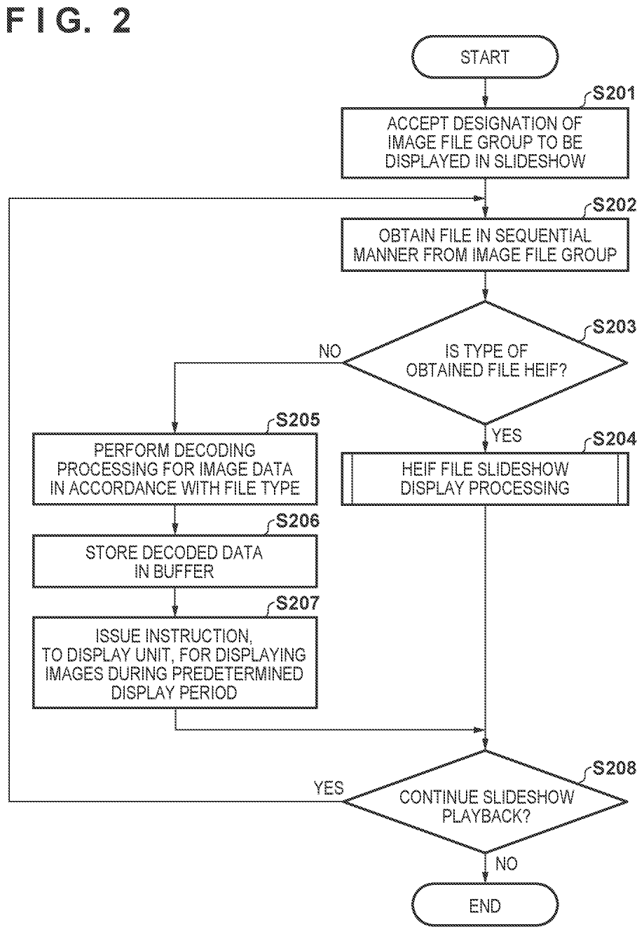

Next, the flow of slideshow playback processing for image files on the information processing apparatus 100 will be described with reference to FIG. 2 to FIG. 9. FIG. 2 is a flowchart of slideshow playback processing for image files that is executed by the information processing apparatus 100. Specifically, FIG. 2 shows the flow of processing for performing slideshow playback of one or more still image files included in a plurality of image files in accordance with each image file format. Each step of the flowchart of FIG. 2 represents processing executed by software realized by the CPU 102, the encoding/decoding unit 105, or the metadata processing unit 106. Note that in the following description, it is assumed that the expression “CPU 102” refers to software processing executed by the CPU 102.

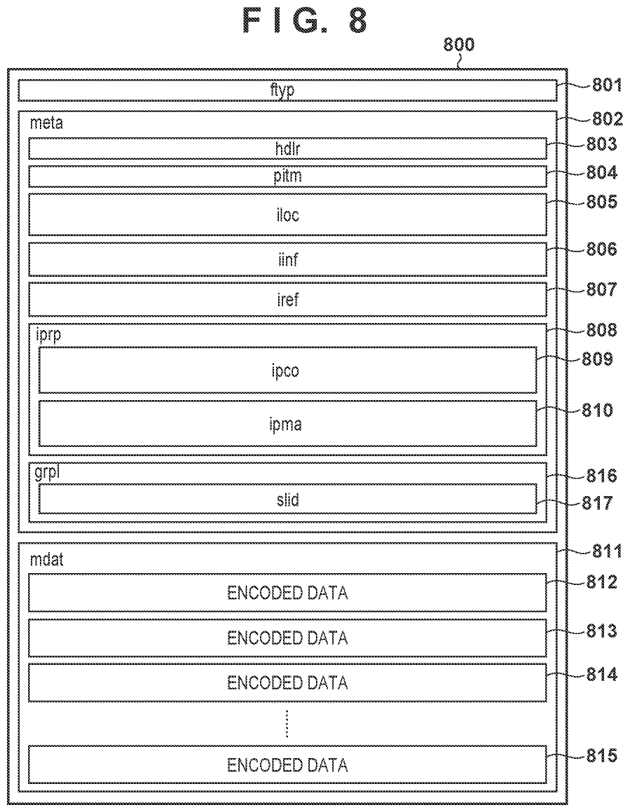

FIG. 8 shows a structure of an HEIF file 800, which is one example of image files compliant with the HEIF file format, among files that are played back in a slideshow by the information processing apparatus 100 in the present embodiment. The HEIF file 800 includes a metadata storage region 802 (MetaBox (meta), a metadata region) and an encoded data storage region 811 (MediaDataBox (mdat), an image data region). The HEIF file 800 also includes FileTypeBox (ftyp, a region 801) for identifying a file type.

In the slideshow playback processing for image files, first, the CPU 102 accepts designation of a plurality of image files (an image file group) to be played back in a slideshow based on a user instruction issued via the user interface unit 108 in step S201. This can be, for example, designation of all image files that are stored in a folder and the like stored in the RAM 103 or the ROM 104, designation of all image files having the file generation dates/times within a specific period, or designation of a list and the like of image files to be played back in a slideshow. Alternatively, a plurality of image files stored in a specific network folder, cloud, and the like may be designated. It is sufficient that the designated image files be image files of HEIF, JPEG, GIF, BMP, TIFF, RAW, and the like, and they are not limited to a specific format. Alternatively, as processing for accepting this designation, the CPU 102 may automatically obtain image files that have been stored in a predetermined storage location in advance. It is sufficient that the image file group accepted through this designation be image data, and it may not be stored as image files.

Next, in step S202, the CPU 102 obtains an image file in a sequential manner from the image file group accepted in step S201. Note that in the present processing, the CPU 102 may not obtain an image file that has already been played back until the obtainment of every designated file is completed, or may obtain an image file randomly regardless of whether it has already been played back, from the image file group. Also, the CPU 102 may accept/obtain a new image file, even during slideshow playback, by repeating the processing of steps S201 and S202 repeatedly. Furthermore, the order of the obtainment in step S202 may be the order that has been decided on based on arbitrary designation that has been made with respect to image files, or may be the order based on designation that has been made by the user via the user interface unit 108. In addition, the CPU 102 may separately prepare a slideshow playback list, and obtain the image file based on the file information/order described in the list.

In step S203, the CPU 102 confirms the type (file type) of the obtained image file. When the obtained file is an image file compliant with the HEIF file format, processing proceeds to step S204; when the obtained file is an image file in another format, and processing proceeds to step S205.

In step S205, the encoding/decoding unit 105 performs decoding processing for image data in accordance with the file type. Specifically, first, the metadata processing unit 106 analyzes metadata and the like for each file type. Then, for each file type, the encoding/decoding unit 105 obtains stored image data, executes decoding processing, and generates decoded data. Next, in step S206, the encoding/decoding unit 105 transfers and stores the generated decoded data to the output buffer in the RAM 103. In step S207, the CPU 102 issues, to the display unit 107, an instruction for displaying images on the display unit 107 during a display period that has been decided on by the information processing apparatus 100 in advance. The display unit 107 displays the images based on this instruction. Note that it is desirable for the present processing to be completed during the display period for an image that is displayed immediately before or earlier, and the display unit 107 can display the images after the completion of display of the image that is displayed immediately before. Also note that it is permissible to adopt a configuration in which slideshow playback can be temporarily paused (i.e., display of the images on the display unit 107 is temporarily paused) by an operation that is performed by the user and the like via the user interface unit 108 and the like during the display period that has been decided on in advance. Furthermore, no limitation is intended by the slideshow based on the period that has been decided on in advance; the display unit 107 may disable automatic switching (i.e., a slideshow function) based on an instruction from the CPU 102. In this case, for example, the display unit 107 may switch displays only based on an instruction issued by the user via the user interface unit 108, such as a click and a tap.

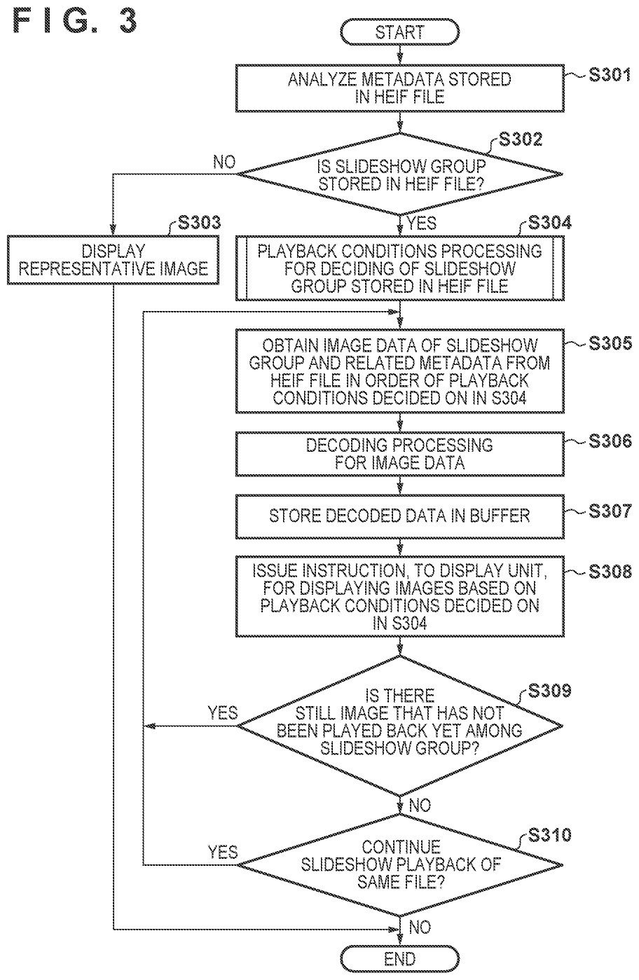

In step S204, the information processing apparatus 100 performs slideshow display processing for the HEIF file. The details of this slideshow display processing for the HEIF file will be described later using FIGS. 3 to 9.

After step S207 or S204, processing proceeds to step S208. In step S208, the CPU 102 determines whether to continue the slideshow playback. In the present determination processing, the slideshow playback is continued when the image file group designated in step S201 includes an image file that has not been played back in a slideshow yet. Also, the information processing apparatus 100 can continue the slideshow playback when repetitive playback has been set in advance via the user interface unit 108 and the like. When the slideshow playback is to be continued in this way, the information processing apparatus 100 repeatedly performs processing from step S202 to step S208. The slideshow playback is executed by sequentially reading out and displaying the image files in the foregoing manner.

### Slideshow Display Processing for HEIF File

Next, the flow of the slideshow display processing for the HEIF file in step S204 of FIG. 2 will be described using FIG. 3. FIG. 3 is a flowchart of the slideshow display processing for the HEIF file. Note that the slideshow display processing for the HEIF file in FIG. 3 is not limited to being performed as the processing in step S204, and may also be performed when the HEIF file has been opened directly by, for example, an instruction issued by the user via the user interface unit 108.

In step S301, the metadata processing unit 106 analyzes metadata stored in the HEIF file. The structure of the metadata to be analyzed is a file format having the structure that is shown in FIG. 8 as one example. The metadata processing unit 106 reads out and analyzes metadata stored in the region 801 (FileTypeBox (ftyp)) and a region 803 (HandlerBox (hdlr)) of FIG. 8. It is expected that the handler type of MetaDataBox (meta) designated as hdlr of the HEIF file to be analyzed is “pict”. Next, the metadata processing unit 106 reads out and analyzes metadata stored in the metadata storage region 802 (MetaBox (meta)). Note that the metadata analyzed here is deployed to and held in the RAM 103, and is used in decoding processing for image data in step S306, together with encoded data stored in the encoded data storage region 811 (MediaDataBox (mdat)).

Next, in step S302, the metadata processing unit 106 determines whether a slide show group (identification information intended for slideshow display) is stored in the HEIF file. As a specific example of processing, first, the metadata processing unit 106 analyzes whether GroupListBox (grpl) of a region 816 in FIG. 8 is stored in the HEIF file. When GroupListBox (grpl) is stored, the metadata processing unit 106 further analyzes whether SlideshowEntityToGroupBox (slid) of a region 817 is stored in the region 816. When SlideshowEntityToGroupBox is stored, the metadata processing unit 106 determines that the slide show group is stored in the HEIF file. When the slide show group is not stored in the HEIF file, processing proceeds to step S303; when the slide show group is stored in the HEIF file, processing proceeds to step S304. Note that although whether the slide show group is stored is determined based on whether SlideshowEntityToGroupBox is stored in the present embodiment, whether slide show data is stored as MovieBox (moov) may be determined. This also includes a case where slide show data is stored using the structure of derived visual tracks in the ISO base media file format, which is currently considered to be standardized as ISO/IEC 23001-16, and a case where slide show data is stored as an image sequence.

When the slide show group is not stored in the HEIF file (NO of step S302), the display unit 107 displays image data (a representative image) indicated by item_id designated in PrimaryItemBox (pitm) of a region 804 in FIG. 8 in step S303. A description is now given of a specific example of the processing of step S303.

First, based on information indicated by ItemInfoBox (iinf) of a region 806, the metadata processing unit 106 analyzes what kind of image item the image item identified by item_id designated in PrimaryItemBox is. For example, when “hvc1” has been designated, it indicates that the type of the image item is an HEVC encoded image. Next, the metadata processing unit 106 analyzes whether another item_id is referred to by analyzing a region 807 (ItemReferenceBox (iref)); when another item_id is referred to, similar analysis is performed also with respect to the image item that is referred to. For example, when reference_type is “dimg”, it means that the type of the image item is a derived image, and the metadata processing unit 106 analyzes and obtains information of an image that serves as the origin of the derived image. Note that when there is no reference relationship, this information is not used. Next, the metadata processing unit 106 analyzes ItemLocationBox (iloc) of a region 805, and obtains the storage location of each bitstream of the image data within the file. Then, the location at which the image data exists within MediaDataBox of the region 811 is specified, and corresponding encoded data (region 812 to region 815) is obtained.

Next, the metadata processing unit 106 obtains attribute information of the image item by analyzing metadata. ItemProperty indicating attribute information of the image is stored in ItemPropertyContainerBox (ipco) (corresponding to a region 809) inside ItemPropertiesBox (iprp) of a region 808. Also, information indicating the association between each image item and the attribute information is stored in ItemPropertyAssociationBox (ipma) (corresponding to a region 810). Here, each image item is associated with the attribute information inside ipco in order. The metadata processing unit 106 obtains the attribute information of the image item by analyzing such metadata. For example, hvcC and ispe stored in ItemPropertyContainerBox (ipco) are respectively attribute information indicating an HEVC encoding parameter and attribute information indicating an image size. The image data is obtained based on the metadata analyzed by the metadata processing unit 106, and then the encoding/decoding unit 105 executes decoding processing with respect to the obtained image data, thereby generating decoded data. The encoding/decoding unit 105 transfers and stores the generated decoded data to the output buffer in the RAM 103. The CPU 102 issues an instruction for displaying the image on the display unit 107 during the display period that has been decided on by the information processing apparatus 100 in advance. The display unit 107 displays the image based on this instruction. Note that when the current time is in the middle of the display period for an image that is displayed immediately before or earlier, the display unit 107 displays the image after the completion of display of the image that is displayed immediately before.

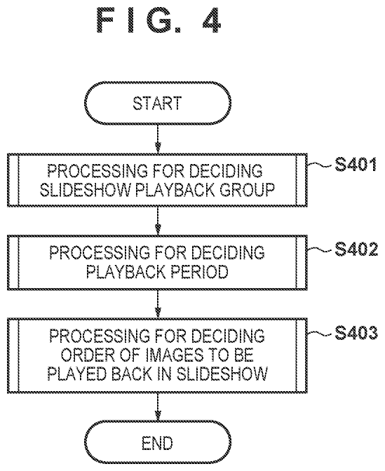

When the slide show group is stored in the HEIF file (YES of step S302), the information processing apparatus 100 performs playback condition decision processing for the slide show group (an image group designated by the identification information intended for slideshow display) stored in the HEIF file in step S304. The details of this playback condition decision processing for the slide show group will be described later using FIG. 4.

In step S305, the metadata processing unit 106 obtains, from the HEIF file, image data corresponding to image items in the slide show group (the image group designated by the identification information intended for slideshow display), as well as related metadata, in the order of the playback conditions that were decided on in step S304. The present processing is similar to step S303, except that corresponding item_ids are obtained from SlideshowEntityToGroupBox instead of item_id that is obtained from PrimaryItemBox in step 303.

In step S306, the encoding/decoding unit 105 generates decoded data by executing decoding processing based on the metadata and the image data obtained in step S305. Next, in step S307, the encoding/decoding unit 105 transfers and stores the generated decoded data to the output buffer in the RAM 103. In step S308, the CPU 102 issues, to the display unit 107, an instruction for displaying images on the display unit 107 based on the playback conditions that were decided on in step S304. That is to say, the CPU 102 performs display control for displaying the image group on the display unit 107 in accordance with the playback conditions that were decided on in step S304. The display unit 107 displays the images based on the instruction from the CPU 102. Note that when the current time is in the middle of the display period for an image that is displayed immediately before, the display unit 107 displays the images after the completion of display of the image that is displayed immediately before.

In step S309, the CPU 102 confirms whether there still is an image that has not been played back yet among the images of the slide show group to be played back in the order of the playback conditions that were decided on in step S304. When there is an image that has not been played back yet, processing proceeds to step S305, and processing is repeated from step S305. When there is no image that has not been played back yet, processing proceeds to step S310, and the CPU 102 determines whether to continue the slideshow playback of the same file. Through this processing, whether there is a slide show group that has not been played back yet is determined. In addition, this determination may be made based on, for example, the settings on the information processing apparatus 100. When the slideshow playback of the same file is to be continued, processing proceeds to step S305; when the slideshow playback of the same file is not to be continued, processing is ended.

### Playback Condition Decision Processing for Slide Show Group

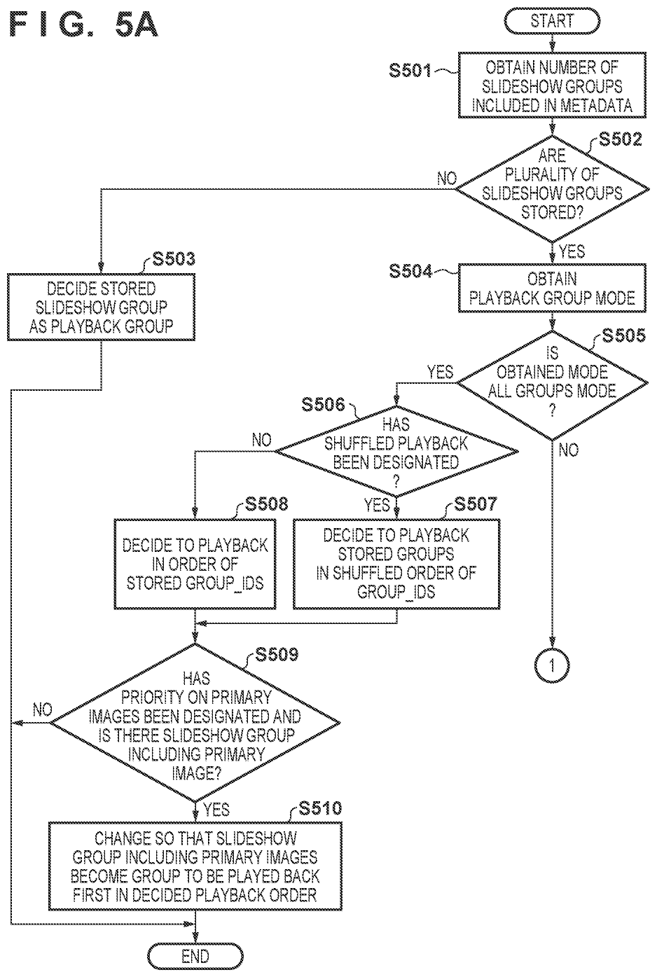

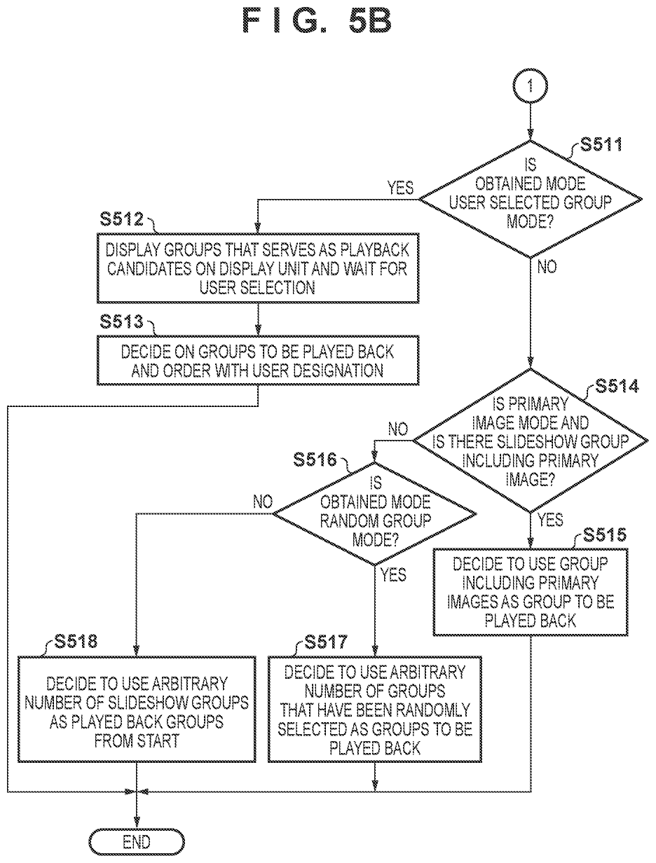

Next, the flow of the playback condition decision processing for the slide show group in step S304 of FIG. 3 will be described using FIG. 4. FIG. 4 is a flowchart of the playback condition decision processing for the slide show group. The information processing apparatus 100 performs processing for deciding on a slideshow playback group in step S401, then performs processing for deciding on a playback period (playback display period) in step S402, and finally performs processing for deciding on the order of images to be played back in a slideshow in step S403. The following describes respective processes in steps 401 to 403 with reference to FIGS. 5 to 9.

### (1) Processing for Deciding on Slideshow Playback Group (Step S401)

In a case where a plurality of slide show groups are stored, the present processing decides on which groups are played back in what order. The present processing flow will be described using FIGS. 5A and 5B. FIGS. 5A and 5B are flowcharts of the processing for deciding on the slideshow playback group.

In step S501, the metadata processing unit 106 obtains the number of slide show groups included in metadata. Specifically, the number of SlideshowEntityToGroupBoxes (slids) stored inside GroupListBox (grpl) of the region 816 in FIG. 8 is obtained. Next, in step S502, the metadata processing unit 106 confirms whether the number of slide show groups obtained in step S501 is equal to or larger than two (whether a plurality of pieces of identification information intended for slideshow display are stored). When two or more slide show groups are stored, processing proceeds to step S504; when only one slide show group is stored, processing proceeds to step S503. In step S503, the metadata processing unit 106 decides that the stored slide show group is to be used as a group to be played back in a slideshow, and ends processing.

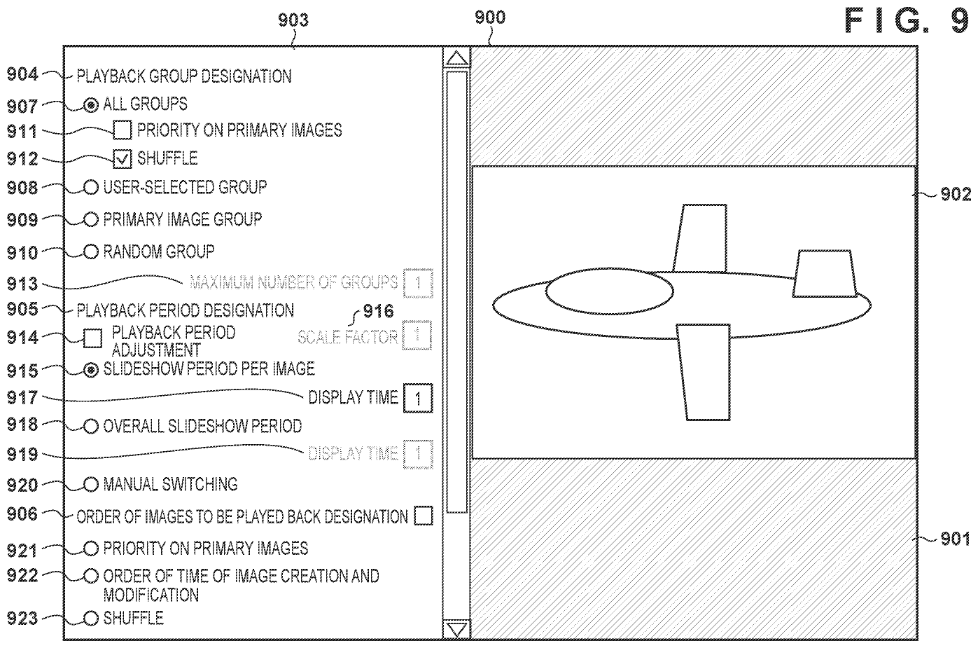

In step S504, the CPU 102 obtains a playback group mode designated by the user. A description is now given of designation of a playback group mode with reference to FIG. 9. FIG. 9 is a diagram showing examples of a setting screen and a slideshow display screen on the display unit 107 of the information processing apparatus 100. In FIG. 9, a screen 900 is the entirety of a screen displayed by the display unit 107. A region 902 is a region for displaying an image that is played back and displayed. A region 901 is a margin portion of a displayed screen, and is a region that is displayed when a displayed image is smaller than a region for image display. A setting region 903 is a setting region for slideshow playback conditions. The setting region 903 includes a setting region for playback group mode designation 904 (buttons 907 to 910, checkboxes 911 to 912, and an input box 913), a setting region for playback period designation 905 (a checkbox 914, buttons 915, 918, 920, and input boxes 916, 917, 919), and a setting region for designating the order of images to be played back (a checkbox 906 and buttons 921 to 923). In the processing shown in FIGS. 5A and 5B, the setting region for playback group mode designation 904 (the buttons 907 to 910, checkboxes 911 to 912, and input box 913) is used.

In step S504, the CPU 102 obtains a playback group mode based on the selection (designation) of one of the buttons 907 to 910 that has been made via the user interface unit 108 and the like. The button 907 corresponds to an all groups mode, the button 908 corresponds to a user-selected group mode, the button 909 corresponds to a primary image group mode, and the button 910 corresponds to a random group mode. In the all groups mode (the selection of the button 907), in a case where a plurality of slide show groups are stored in the HEIF file, all slide show groups are selected as groups targeted for slideshow playback. The user-selected group mode (the selection of the button 908) is a mode that, at the start of slideshow playback, causes the user to select a slide show group to be played back. The primary image group mode (the selection of the button 909) is a mode in which a slide show group that includes primary image items is selected as a group targeted for slideshow playback. The random group mode (the selection of the button 910) is a mode in which the CPU 102 randomly selects up to a designated maximum number of groups as groups to be played back.

Next, in step S505, the CPU 102 determines whether the playback group mode obtained in step S504 is the all groups mode (button 907). Specifically, when the button 907 is selected in FIG. 9, the CPU 102 obtains setting information that is internally held, and determines whether this setting information is information indicating the all groups mode. In the following description, the CPU 102 similarly determines, based on information that has been set/selected on the display unit 107 (screen UI), whether information that is internally held corresponds to this set information. Note that FIG. 9 shows that the all groups mode is selected as the playback group mode (the button 907 is selected) as one example. When the obtained playback group mode is the all groups mode, processing proceeds to step S506, and the order of slide show groups to be played back is decided on in subsequent processing steps. When the selected playback group mode is a mode other than the all groups mode, processing proceeds to step S511.

In step S506, the CPU 102 confirms whether the checkbox 912, which indicates shuffle, is selected in FIG. 9 by an operation performed by the user via the user interface unit 108 and the like. The example illustrated in FIG. 9 shows that the checkbox 912 (shuffle) is selected. When the checkbox 912 (shuffle) is selected, processing proceeds to step S507; when it is not selected, processing proceeds to step S508. In step S507, the CPU 102 decides to play back the stored slide show groups in the order of randomly-shuffled group IDs. On the other hand, in step S508, the CPU 102 decides to playback the stored slide show groups in the order of group_ids for identifying the slide show groups. The playback order can be either ascending order or descending order of the numerical values of group_ids. For this reason, the display unit 107 may, under a command from the CPU 102, separately provide a display for prompting the user to designate whether the playback is to be performed in ascending order or descending order.

Next, in step S509, the CPU 102 confirms whether the checkbox 911, which indicates priority on primary images, is selected (checked) in FIG. 9 by an operation performed by the user via the user interface unit 108 and the like. The example illustrated in FIG. 9 shows that the checkbox 911 (priority on primary images) is not selected. When the checkbox 911 (priority on primary images) is selected, processing proceeds to step S510; when it is not selected, processing is ended. In step S510, the CPU 102 shuffles the order of playback of groups that was decided on in step S507 or step S508 so that a group including primary images becomes a group to be played back first, uses the shuffled order as the order of playback of groups, and ends processing. Note that nothing is done in the present step when a group that includes primary images does not exist.

In step S511, the CPU 102 determines whether the playback group mode obtained in step S504 is the user-selected group mode (button 908). When the obtained playback group mode is the user-selected group mode, processing proceeds to step S512; when the obtained playback group mode is another mode, processing proceeds to step S514.

In step S512, in response to a command from the CPU 102, the display unit 107 displays groups that serve as playback candidates on the screen, and waits for a user selection. The user designates groups to be played back and the order of playback thereof from the candidates for groups to be played back, which are displayed on the screen of the display unit 107, via the user interface unit 108. In step S513, the CPU 102 decides on the groups to be played back and the order of playback in accordance with the user designation, and ends processing. Note that in the user-selected group mode, the number of groups that can be designated by the user may be limited to one, or a plurality or all of the groups may be selectable. Furthermore, the user may be able to select (designate) a random playback order (random playback), or may be able to select playback of only a group that includes primary images, via the user interface unit 108. While the present mode is favorable when slideshow playback is performed by directly opening the HEIF file, it may be applicable to slideshow playback of FIG. 2. In this case, a slideshow playback sequence is temporarily paused until the user makes the selection. Furthermore, when a certain period has elapsed without the user selecting a group, the CPU 102 may decide to select and playback a group in a mode that has been decided on in advance.

In step S514, the CPU 102 determines whether the playback group mode obtained in step S504 is the primary image group mode (button 909). Also, when the primary image group mode is selected, the CPU 102 further confirms whether there is a slide show group that includes primary images. When the primary image group mode is selected and there is a slide show group that includes primary images, processing proceeds to step S515; otherwise, processing proceeds to step S516.

In step S515, the CPU 102 decides to use the slide show group that includes primary images as the group to be played back, and ends processing. Note that when there are a plurality of groups that include primary images, the CPU 102 may decide to use all of these groups as playback targets, or may arbitrarily select playback targets from the groups that include primary images so that the number of the selected groups is equal to or smaller than the number that has been designated by the user in the input box 913, which indicates the maximum number of groups in FIG. 9. Also, the CPU 102 may select only one group including primary images.

In step S516, the CPU 102 determines whether the playback group mode obtained in step S504 is the random group mode (button 910). When the obtained playback group mode is the random group mode, processing proceeds to step S517; otherwise, processing proceeds to step S518. In the case of the setting screen shown in FIG. 9, when the primary image mode (button 909) is selected and a group that includes primary images is not stored, processing proceeds to step S518.

In step S517, the CPU 102 decides to use an arbitrary number of groups that have been randomly selected as groups to be played back, and ends processing. The user can designate this arbitrary number in the input box 913 of FIG. 9, which indicates the maximum number of groups; this arbitrary number may be the number that has been decided on by the information processing apparatus 100 in advance. Furthermore, the CPU 102 may randomly decide on the order of groups to be played back as well. In step S518, the CPU 102 selects the arbitrary number of groups from the start in ascending order or descending order of group_ids, decides to use these groups as groups to be played back in this order, and ends processing.

### (2) Processing for Deciding on Playback Period (Step S402)

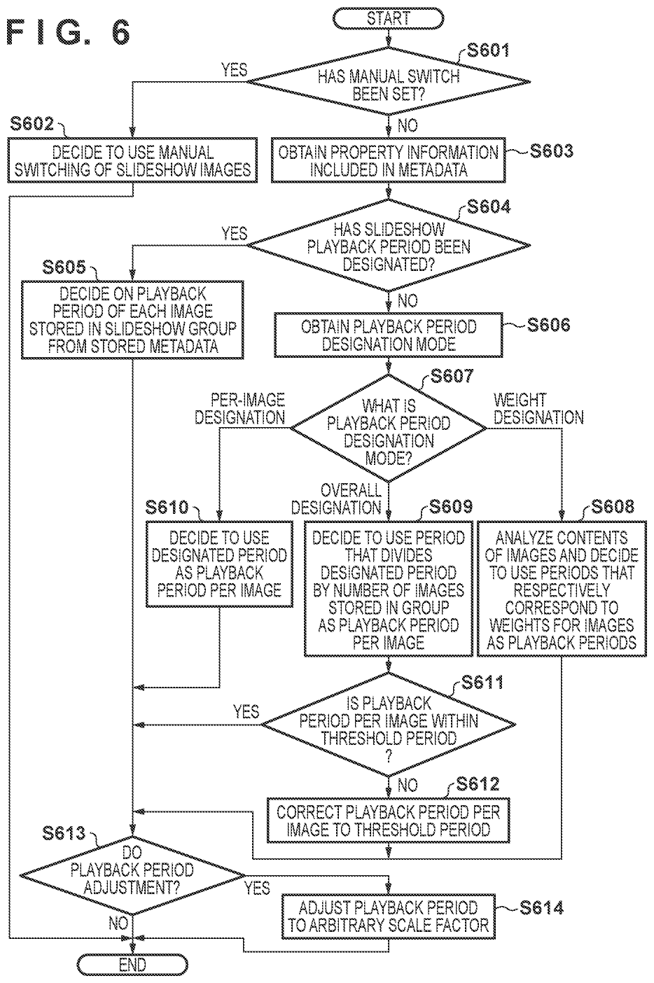

The present processing decides on a period for displaying images. The present processing flow will be described using FIG. 6 and FIG. 9. FIG. 6 is a flowchart of the processing for deciding on a playback period of the slide show group. In the processing shown in FIG. 6, the setting region for playback period designation 905 (the checkbox 914, buttons 915, 918, 920, and input boxes 916, 917, 919) is used.

In step S601, the CPU 102 confirms whether a manual switch setting has been configured. Specifically, the CPU 102 confirms whether the button 920, which indicates manual switching, is selected in FIG. 9. When the button 920 is selected, processing proceeds to step S602. In step 602, the CPU 102 decides to use manual switching of slideshow images. That is to say, the CPU 102 decides to switch between images at the time of slideshow playback in accordance with a user operation performed via the user interface unit 108. Note that this manual switch setting is also applicable to the processing flows of FIG. 2 and FIG. 3. For example, in a case where manual switching has been set, a display period in step S207 and step S308 is a period until the user performs a switch operation via the user interface unit 108.

On the other hand, when the button 920 is not selected (another designation of a playback period is selected), processing proceeds to step S603. In step S603, the metadata processing unit 106 obtains property information included in metadata. Specifically, the metadata processing unit 106 confirms whether a slideshow playback period (information related to the slideshow playback period) has been designated (whether property information that designates the slideshow playback period has been associated) with respect to group_id of the slide show group and item_ids stored in the slide show group. In addition, when MovieBox is stored in the file, the metadata processing unit 106 confirms whether a playback period for that track has been designated.

Next, in step S604, when the slideshow playback period has been designated (the property information that designates the slideshow playback period has been associated) in step S603, processing proceeds to step S605; when the slideshow playback period has not been designated, processing proceeds to step S606. In step S605, the CPU metadata 102 decides on a playback period of each image stored in the slide show group from metadata stored in the file. Note that there may be a case where metadata has been designated only with respect to the slide show group or a part of images therein. Therefore, the CPU 102 may repeatedly perform processing prior to step S604 to step S613 for the slide show group and for every image stored in this slide show group.

In step S606, the CPU 102 obtains a playback period designation mode that has been designated by the user with respect to the information processing apparatus 100. Specifically, the CPU 102 confirms whether the button 915 indicating a per-image slide show period, or the button 918 indicating an overall slideshow period, in FIG. 9 is selected. Furthermore, although not shown in FIG. 9, it is permissible to adopt a configuration that allows for designation of a mode that decides on a playback period (display period) by applying weights in accordance with the contents of images to be displayed.

In step S607, processing branches out in accordance with the mode obtained in step S606. When the button 915 is selected (the mode that designates the per-image slideshow period), processing proceeds to step S610; when the button 918 is selected (the mode that designates the overall slideshow period), processing proceeds to step S609. Also, when the aforementioned mode that decides on a playback period in accordance with weights, processing proceeds to step S608.

In step S610, the CPU 102 decides to use a period designated by the user as a playback period per image. Specifically, the CPU 102 decides to use a period of the numerical value designated in the input box 917 for a display period in FIG. 9 as the playback period. Note that although it is expected to use such units as seconds and milliseconds as a time unit for this numerical value, other units may be used, and it is sufficient that the time unit be a parameter with which a display period can be designated.

In step S609, the CPU 102 obtains a playback period designated by the user, and decides to use a value (period) calculated by dividing the obtained playback period by the number of images stored in the group as a playback period per image. Specifically, the CPU 102 obtains the numerical value designated in the input box 919 for a display period in FIG. 9. Note that although it is expected to use such units as hours, minutes, and seconds as a time unit for this numerical value, other units may be used, and it is sufficient that the time unit be a parameter with which a display period can be designated. Next, the CPU 102 obtains the value of num_entities_in_group of SlideshowEntityToGroupBox stored in the HEIF file. The CPU 102 decides to use the value calculated by dividing the numerical value (period) designated in the input box 919 for a display period by the value of num_entities_in_group as the playback period per image. Note that when a plurality of slide show groups are stored in the file, the CPU 102 may decide on a playback period on a per-group basis, or may be able to set a playback period for the entirety of the file. For example, the CPU 102 sets a period calculated by dividing the numerical value (period) designated in the input box 919 for a display period by the sum of the values of num_entities_in_group of all SlideshowEntityToGroupBoxes.

Next, in step S611, the CPU 102 confirms whether the playback period per image falls within a threshold period. When the playback period per image falls within the threshold period, processing proceeds to step S613; when the playback period per image does not fall within the threshold period, processing proceeds to step S612. In step S612, the CPU 102 corrects the playback period per image to the threshold period. Note that the threshold may be a value that has been set on the information processing apparatus 100 in advance, or may be a value that can be designated by the user on the screen UI shown in FIG. 9. An object of the processing of steps S611 and S612 is to prevent the playback period per image from becoming too short or too long depending on the number of images stored in the slide show group and the designation of the overall playback period.

In step S608, the CPU 102 analyzes the contents of the images, and decides to use periods that respectively correspond to the weights for the images as playback periods. In the present processing, for example, an image that has been found to show a specific person or object through image analysis is played back for a long period, and a display period is adjusted depending on the number of characters in a case where characters to be displayed are embedded in an image.

Next, in step S613, the CPU 102 determines whether to adjust the playback period. Specifically, the CPU 102 confirms whether the checkbox 914, which indicates playback period adjustment, in FIG. 9 is selected. When the checkbox 914 is selected, processing proceeds to step S614; when it is not selected, processing is ended. In step S614, the CPU 102 adjusts the playback period to an arbitrary scale factor, and ends processing. Specifically, the CPU 102 obtains the value designated in the input box 916 for a scale factor in FIG. 9, and corrects the image playback period that was decided on in steps prior to step S613. Note that when the corrected value (period) does not fall within the threshold period used in step S612, the CPU 102 may further make a correction so that the value falls within the threshold period. Furthermore, although the scale factor can be designated as a numerical value in the present embodiment, a method of designating slow playback or fast-forward playback may be used.

### (3) Processing for Deciding on Order of Images to be Played Back in Slideshow (Step S403)

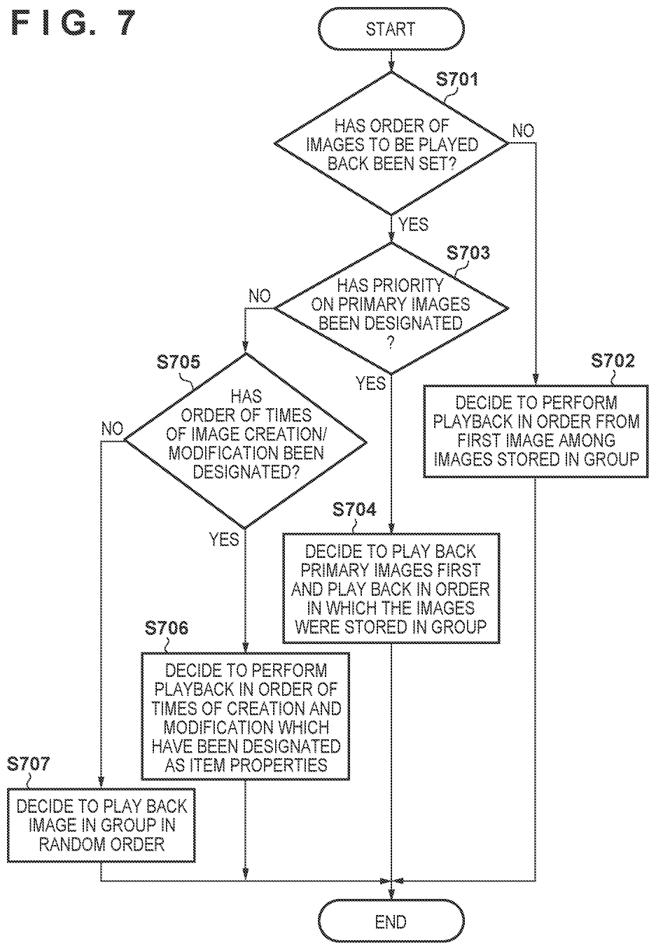

With regard to the images stored in the slide show group, the present processing decides on from which image the playback is performed and in what order the images are played back. The present processing flow will be described using FIG. 7 and FIG. 9. FIG. 7 is a flowchart of the processing for deciding on the order of images to be played back in the slide show group. In the processing shown in FIG. 7, the setting region for designating the order of images to be played back (the checkbox 906 and buttons 921 to 923) is used.

In step S701, the CPU 102 confirms whether the order of images to be played back in a slideshow has been set. Specifically, the CPU 102 determines whether the checkbox 906, which indicates designation of the order of images to be played back, is selected (checked) in FIG. 9. When the checkbox 906 is selected, processing proceeds to step S703; when it is not selected, processing proceeds to step S702. In step S702, the CPU 102 decides to perform playback in order from the first image among the images stored in the group, and ends processing. Specifically, the CPU 102 decides to play back pieces of image data indicated by item_ids stored in SlideshowEntityToGroupBox in the storage order of item_ids.

In step S703, the CPU 102 confirms whether priority on primary images has been designated. Specifically, the CPU 102 confirms whether the button 921, which indicates priority on primary images, is selected in FIG. 9. When the button 921 is selected, processing proceeds to step S704; when it is not selected, processing proceeds to step S705. In step S704, the CPU 102 decides to play back primary images stored in the group first, and thereafter play back the images in a slideshow in the order of item_ids stored in the group. Note that when no primary image is stored in the file, the CPU 102 decides to perform playback in the storage order from the image indicated by the first item_id in the group, similarly to step S702.

In step S705, the CPU 102 confirms whether the order of the times of image creation/modification has been designated. Specifically, the CPU 102 confirms whether the button 922, which indicates the order of the times of image creation and modification, is selected in FIG. 9. When the button 922 is selected, processing proceeds to step S706; when it is not selected, processing proceeds to step S707. A case where processing proceeds to step S707 is a case where the button 923 indicating shuffle is selected in FIG. 9. In step S707, the CPU 102 decides to play back the images in the group in a random order, and ends processing.

In step S706, the CPU 102 decides to perform playback in the order of the times of creation and modification, which have been designated as item properties, and ends processing. Specifically, the playback order is decided on based on CreationTimeProperty which is properties indicating the times of creation, as well as ModificationTimeProperty which is properties indicating the times of modification, stored in ItemPropertyContainerBox (ipco) (corresponding to the region 809) inside ItemPropertiesBox (iprp) of the region 808 in FIG. 8. Note that CreationTimeProperty and ModificationTimeProperty are item properties that have been considered as ISO/IEC 23008-12:2017/DAM2. Note that when these properties are not associated with any image, the CPU 102 may decide to perform playback in the storage order from the image indicated by the first item_id in the group, similar to step S702. This case is a case where the aforementioned ModificationTimeProperty or CreationTimeProperty is not associated in ItemPropertyAssociationBox (ipma) indicating the association between each image item and attribute information. Furthermore, in a case where images that are associated with and images that are not associated with the aforementioned properties coexist, the CPU 102 may decide to perform playback from an image with the newest times of creation and modification, or an image with the oldest times of creation and modification, among the associated images. Note that the CPU 102 may make the decision in step S706 with use of only one of the creation period and the time of modification. Also, the CPU 102 may decide to perform playback in order from the newest image or the oldest image based on both of the time of creation and the time of modification. Furthermore, regarding the playback order, the CPU 102 may decide to first perform playback from an image with the newest or oldest time of creation and time of modification, and play back subsequent images in the order of storage in the group. On the other hand, with respect to all images, the CPU 102 may decide to start playback from an image with the newest or oldest creation period and time of modification, and play back subsequent images in the order of the times thereof.

Note that in a case where there are a plurality of groups to be played back, the present processing flow is performed on a per-group basis.

As described above, according to the foregoing embodiment, the information processing apparatus 100 first determines whether one or more pieces of identification information intended for slideshow display of images are stored in a metadata storage region in an image file that stores encoded data and metadata of one or more images. When the identification information is stored, the information processing apparatus 100 decides on a playback method for the image group that is stored with a purpose of slideshow display of still images based on the settings configured by the user, and performs playback based on the playback method that has been decided on. Note that a different configuration may be adopted as long as it uses a method of deciding on a playback method based on information specified by the information processing apparatus 100 when the image file stores information intended for a slideshow.

According to the present embodiment, whether an identifier intended for slideshow display is stored in an HEIF file is determined, and when the identifier is stored, a slideshow playback method is decided on by obtaining information that can be set on the information processing apparatus 100. This makes it possible to decide on the behaviors at the time of playback in a case where an image group intended for a slideshow is stored in an HEIF file. Furthermore, in a case where a plurality of image groups intended for a slideshow are stored in one HEIF file, it is possible to designate, in the form of the settings that can be designated on the information processing apparatus 100, such behaviors as which image group intended for a slideshow is to be played back, and in what order playback is to be performed. In addition, a display period at the time of slideshow playback/display can be designated on a per-image basis or on a per-group basis. This enables fine designation of an overall display period or a display period per image. Moreover, in order to enable the user to arbitrarily make a selection, the settings that can be designated directly by the user are provided, and the user can configure the settings in accordance with a file. In this way, slideshow playback that suits the preference of the user can be performed individually on a per-file basis. It is also possible to designate from which image playback is started, as well as the playback order, with respect to the images stored in an image group intended for slideshow playback. Such designation makes it possible to flexibly designate the behaviors at the time of playback in a case where an image group intended for a slideshow is stored in an HEIF file.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While various embodiments of the present disclosure have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-099614, filed Jun. 8, 2020 which is hereby incorporated by reference herein in its entirety.

What is claimed is:

1. An information processing apparatus that displays, on a display unit, an image included in an image file that conforms with a predetermined image file format with a structure that includes an image data region for storing an image and a metadata region for storing metadata related to the image, the information processing apparatus comprising:
a decision unit configured to, in a case where identification information related to slideshow display is stored in the metadata region, decide on a playback condition for an image group designated by the identification information in accordance with setting information set on the information processing apparatus; and
a display control unit configured to perform slideshow display of the image group on the display unit in accordance with the playback condition that has been decided on by the decision unit.

2. The information processing apparatus according to claim 1,
wherein the decision unit decides on the playback condition based on the setting information and the metadata stored in the metadata region.

3. The information processing apparatus according to claim 1,
wherein in a case where a plurality of pieces of the identification information are stored, the setting information includes information that designates which image group is to be played back among a plurality of image groups designated by the stored plurality of pieces of identification information.

4. The information processing apparatus according to claim 1,
wherein in a case where a plurality of pieces of the identification information are stored, the setting information includes information that designates a playback order of a plurality of image groups designated by the plurality of pieces of identification information.

5. The information processing apparatus according to claim 1,
wherein the setting information includes information that designates a playback display period of the image group designated by the identification information.

6. The information processing apparatus according to claim 5,
wherein the playback display period is a playback display period of one image included in the image group.

7. The information processing apparatus according to claim 5,
wherein the playback display period is a playback display period of an entirety of the image group.

8. The information processing apparatus according to claim 1,
wherein the setting information includes information that designates execution of switching of displayed images at the time of slideshow playback of the image group designated by the identification information via a user operation.

9. The information processing apparatus according to claim 1,
wherein the setting information includes information that designates a playback order of one or more images included in the image group designated by the identification information.

10. The information processing apparatus according to claim 1,
wherein the setting information is set by a user.

11. The information processing apparatus according to claim 1,
wherein the image file format is HEIF (High Efficiency Image File Format).

12. A control method for an information processing apparatus that displays, on a display unit, an image included in an image file that conforms with a predetermined image file format with a structure that includes an image data region for storing an image and a metadata region for storing metadata related to the image, the control method comprising:
in a case where identification information related to slideshow display is stored in the metadata region, deciding on a playback condition for an image group designated by the identification information in accordance with setting information set on the information processing apparatus; and
performing slideshow display of the image group on the display unit in accordance with the playback condition that has been decided on by the deciding.

13. A non-transitory computer-readable storage medium storing a computer program for causing a computer to execute a control method for an information processing apparatus that displays, on a display unit, an image included in an image file that conforms with a predetermined image file format with a structure that includes an image data region for storing an image and a metadata region for storing metadata related to the image, the control method comprising:
in a case where identification information related to slideshow display is stored in the metadata region, deciding on a playback condition for an image group designated by the identification information in accordance with setting information set on the information processing apparatus; and
performing slideshow display of the image group on the display unit in accordance with the playback condition that has been decided on by the deciding.
